(19) United States
(12) Patent Application Publication
(10) Pub. No.: US 2026/0061882 A1
(43) Pub. Date: Mar. 5, 2026

(54) CHARGING MANAGEMENT METHOD FOR AN ELECTRICALLY OPERATED AGRICULTURAL WORKING VEHICLE

(71) Applicant: DEERE & COMPANY, MOLINE, IL (US)

(72) Inventors: DOMINIK REITER, SCHWENNINGEN (DE); KRUTIN V. RAJANI, BACKNANG (DE)

(21) Appl. No.: 19/291,874

(22) Filed: Aug. 6, 2025

(30) Foreign Application Priority Data
Sep. 4, 2024 (EP) 24198422.8

(51) Int. Cl. B60L 53/68; B60L 58/10; G01C 21/34; G01C 21/36

(52) U.S. Cl. CPC B60L 53/68; B60L 58/10; G01C 21/3469; G01C 21/3679; B60L 2200/40; B60L 2240/72; B60L 2250/16; B60L 2260/54

(57) ABSTRACT

A charging management method includes estimating via a control unit a total energy requirement to be met by a rechargeable electrical energy storage unit for performing an agricultural task, comparing via the control unit the estimated total energy requirement with a present state of charge of the electrical energy storage unit, and when the comparison is not sufficient to complete the agricultural task, the control unit retrieves charging infrastructure information relating to a geographical position of a plurality of charging stations along a route to be covered during the agricultural task from a data memory, ascertains an intention for a travel interruption of the agricultural working vehicle to be inserted, depending on the application, along the route, and assigns the geographical position of the travel interruption to at least one of the plurality of charging stations and outputs a charging recommendation via a data interface.

### CROSS-REFERENCE TO RELATED APPLICATIONS

This application claims priority to European Patent Application No. 24198422.8, filed Sep. 4, 2024, which is hereby incorporated by reference.

### FIELD OF THE DISCLOSURE

The disclosure relates to a charging management method for an electrically operated agricultural working vehicle that comprises a drive system with a rechargeable electrical energy storage unit.

### BACKGROUND

Electrically operated agricultural working vehicles need to be recharged at various intervals.

### SUMMARY

According to an aspect of the present disclosure, a charging management method for an electrically operated agricultural working vehicle having a drive system with a rechargeable electrical energy storage unit includes estimating via a control unit a total energy requirement to be met by the rechargeable electrical energy storage unit for performing an agricultural task on the basis of parameters that are specific to an energy consumption that is to be expected for performing the agricultural task, comparing via the control unit the estimated total energy requirement with a present state of charge of the electrical energy storage unit, and when the comparison that the present state of charge of the electrical energy storage unit is not sufficient to complete the agricultural task without recharging the electrical energy storage unit, the control unit retrieves charging infrastructure information relating to a geographical position of a plurality of charging stations along a route to be covered during the agricultural task from a data memory, ascertains an intention for a travel interruption of the agricultural working vehicle to be inserted, depending on the application, along the route to be covered, and assigns the geographical position of the travel interruption to be inserted depending on the application to at least one of the plurality of charging stations along the route to be covered and outputs a charging recommendation via a data interface.

According to an aspect of the present disclosure, the charging recommendation is output via a display unit that is connected to the data interface which includes displaying a route to be covered to the location of the selected charging station.

According to an aspect of the present disclosure, the charging recommendation is wirelessly transmitted to an external server via a radio interface, and wherein the external server uses the charging recommendation output via the data interface to coordinate a mobile supply vehicle that is to be sent out to carry out the filling operation at the location of the selected charging station.

According to an aspect of the present disclosure, the assignment of the geographical position of the travel interruption to be inserted depending on the application is performed via the control unit depending on selection criteria relating to the accessibility, maximum charging power, the charging current price, and the present operating state of the plurality of charging stations.

According to an aspect of the present disclosure, the assignment of the geographical position of the travel interruption to be inserted depending on the application is performed via the control unit in line with performing the charging operation in a time-optimized manner.

According to an aspect of the present disclosure, the parameters that are specific to the energy consumption that is to be expected are provided to the control unit by an input apparatus, which is used for planning, on the part of the operator, of the agricultural task to be performed.

According to an aspect of the present disclosure, the at least one charging station is selected by the control unit with the aim of the state of charge of the electrical energy storage unit resulting from the time period of the application-dependent travel interruption being sufficient to reach the location of a further charging station.

The above and other features will become apparent from the following detailed description and accompanying drawings.

### BRIEF DESCRIPTION OF THE DRAWINGS

The charging management method according to the disclosure will be explained in more detail in the following with reference to the attached drawings, in which:

FIGS. 1 & 2 show an example embodiment, which is illustrated as a flow diagram, of the charging management method according to the disclosure for an electrically operated agricultural working vehicle; and

FIG. 3 shows a schematically illustrated example embodiment of a driver assistance system provided in the electrically operated agricultural working vehicle, in which the function according to the method is realized.

### DETAILED DESCRIPTION

The embodiments or implementations disclosed in the above drawings and the following detailed description are not intended to be exhaustive or to limit the present disclosure to these embodiments or implementations.

The comparatively high energy requirement for agricultural applications means that the electrical energy storage unit for electrically operated agricultural working vehicles usually has to be recharged several times during a working day. Each of the charging breaks leads to an undesired interruption of the workflow, with a corresponding loss of earnings. In addition, there are increased demands placed on the driver when planning suitable charging opportunities, especially if a timely return to the yard, more precisely to a charging station permanently installed there, is not possible. This is especially true if the agricultural working vehicle is an agricultural tractor, because in this case the actual energy consumption is subject to a plurality of (external) influences, which are difficult for the driver to estimate and therefore unforeseeable, and which are due to the fact that it is used to universally carry out a wide variety of different tasks, including the operation of associated (electrical) add-on or auxiliary devices. In such cases, the driver tends to recharge the electrical energy storage unit too frequently for safety reasons, without any actual need.

In view of this, the object of the present disclosure is to specify a charging management method resulting in an efficient workflow of an electrically operated agricultural working vehicle.

This object is achieved by a charging management method for an electrically operated agricultural working vehicle having the features of one or more embodiments disclosed herein.

In the charging management method, according to the disclosure, for an electrically operated agricultural working vehicle that comprises a drive system with a rechargeable electrical energy storage unit, provision is made for a total energy requirement to be met by the rechargeable electrical energy storage unit for carrying out an agricultural task to be estimated by a control unit on the basis of parameters that are specific to an energy consumption that is to be expected for carrying out the agricultural task, wherein the estimated total energy requirement is compared with a present state of charge of the electrical energy storage unit by the control unit, wherein, if it is found from the comparison that the present state of charge of the electrical energy storage unit is not sufficient to complete the agricultural task without recharging the electrical energy storage unit, the control unit:
(i) retrieves charging infrastructure information relating to the geographical position of a plurality of charging stations along a route to be covered during the agricultural task from a data memory,
(ii) ascertains the necessity or intention for a travel interruption of the agricultural working vehicle to be inserted, depending on the application, along the route to be covered, and
(iii) assigns the geographical position of the travel interruption to be inserted depending on the application to at least one of the plurality of charging stations along the route to be covered and outputs same in the form of a charging recommendation via a data interface.

Such application-dependent travel interruptions typically occur when filling an add-on or auxiliary device attached to an agricultural tractor, which is used to spread a dispersible or liquid consumable located therein, for example fertilizer granules, seed, spraying product or slurry. The filling operation may be carried out by means of a mobile supply vehicle.

Relocating the application-dependent travel interruption to the location of an existing charging station makes it possible to reduce (additional) undesired breaks in the workflow to a minimum amount required.

The charging stations included in the charging infrastructure are part of a public and/or company-owned charging network. These may be permanently installed or else designed to be transportable or mobile.

The electrical energy storage unit, which is housed in the agricultural working vehicle and is usually a rechargeable battery, is generally used to supply energy to an electric traction drive, and possibly also to various electrical auxiliary and/or working assemblies. The latter may be part of the agricultural working vehicle, but also of an add-on or auxiliary device attached thereto.

Advantageous developments of the charging management method according to the disclosure emerge from the one or more embodiments disclosed herein.

The charging recommendation may be output by way of a display unit that is connected to the data interface and is in the form of a corresponding driving instruction, for example by displaying a route to be covered to the location of the selected charging station. In addition, a wireless transmission to an external server is conceivable, said server using the charging recommendation output by way of the data interface to coordinate a mobile supply vehicle that is sent out to carry out the filling operation at the location of the selected charging station.

In order to be able to make an optimum selection from a plurality of possible charging stations, there is the possibility of the assignment of the geographical position of the travel interruption to be inserted depending on the application being carried out by the control unit depending on selection criteria relating to the accessibility, maximum charging power, the charging current price and/or the present operating state of the plurality of charging stations. By way of example, preference is usually given to a charging station that is able to be reached without a great amount of detours, has a charging power that is as high as possible (measured at the respective charging current price) and is not occupied by another road user. Defective charging stations may also be excluded from the outset on the basis of their present operating state. A further selection criterion may be whether the charging station in question is part of a public charging network or whether it is preferably a company-owned charging station.

At least some of the factors mentioned above influence the charging time. It is therefore advantageous if the selection of the charging station is optimized on the basis of one or more of the selection criteria in such a way that the assignment of the geographical position of the travel interruption to be inserted depending on the application is carried out by the control unit in line with carrying out the charging operation in a time-optimized manner.

Furthermore, it is conceivable for the parameters that are specific to the energy consumption that is to be expected to be provided to the control unit by an input apparatus, which is used for planning, on the part of the operator, of the agricultural task to be carried out. The input apparatus may be a networked farm management system, wherein the actual planning is carried out by way of a mobile device (tablet, smartphone) or a work planning app installed thereon. By way of example, a work planning app of this kind is the John Deere Operations Center.

If the agricultural working vehicle is an agricultural tractor, the actual energy consumption is subject to a plurality of influences, which are due to the fact that it is used to universally carry out a wide variety of different tasks, including the operation of associated add-on or auxiliary devices. In such a case, the parameters that are specific to the energy consumption that is to be expected include, for example:
(i) information relating to the efficiency of an electric traction drive comprised by the agricultural tractor, including any electrical auxiliary, and/or working assemblies present, at different operating points,
(ii) data relating to degradation of the charging capacity of the electrical energy storage unit due to its service life,
(iii) the type and scope of the field cultivation measures to be carried out in the course of the planned agricultural task,
(iv) information relating to the type and state of wear of an add-on or auxiliary device used for this purpose, for example working tools engaging in the soil, to driven auxiliary and/or working assemblies (which are operated by way of an electrically operated power take-off of the agricultural tractor or else by means of dedicated electric drive assemblies), to any support wheels or guide wheels present, to the soil cultivation depth, target working rate and target operating points of the driven auxiliary and/or working assemblies, such as predefined target working speeds,
(v) stored data relating to the energy requirement of previous comparable tasks, and/or
(vi) information based on the agricultural area to be cultivated relating to topography, soil type, yield measured values, stock size and density, plant mass, lane profile, weather-dependent soil properties, such as soil moisture and soil condition, as well as the location-dependent compaction due to previous tasks.

These parameters may be linked to an electrical energy consumption that is to be expected in this respect by teaching a corresponding AI model (AI—artificial intelligence). The AI model may be part of the work planning app.

It should be noted that the above list is intended to be understood merely by way of example, rather it may also involve a subselection adapted to the respective requirements and/or combination of further parameters not listed here.

For example, the at least one charging station is selected by the control unit with the aim of the state of charge of the electrical energy storage unit resulting from the time period of the application-dependent travel interruption being sufficient to reach the location of a further charging station, for example in the event of a further application-dependent travel interruption, or else to fully complete the agricultural task. In this way, work interruptions caused by a critical state of charge are able to be at least largely eliminated.

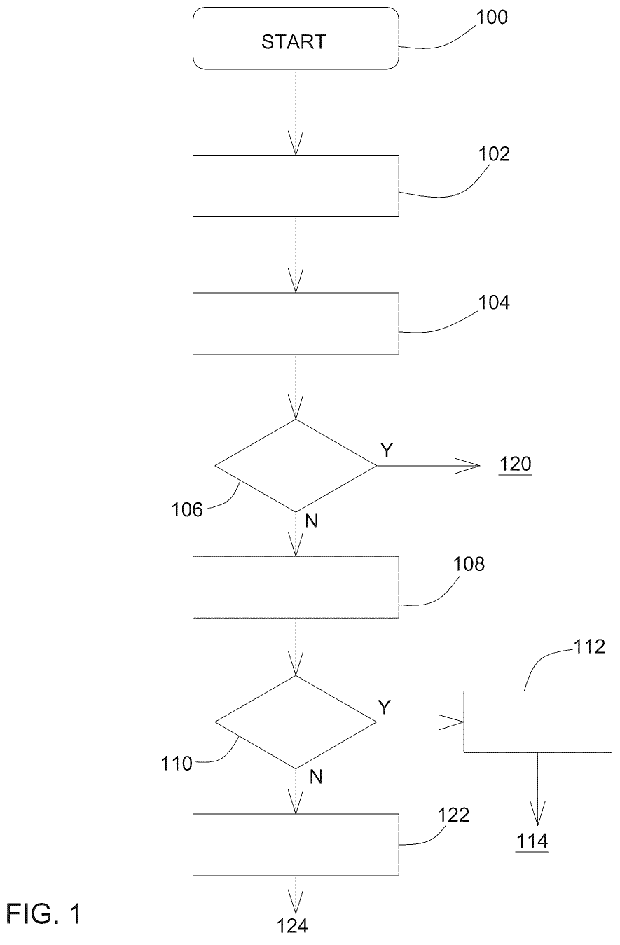

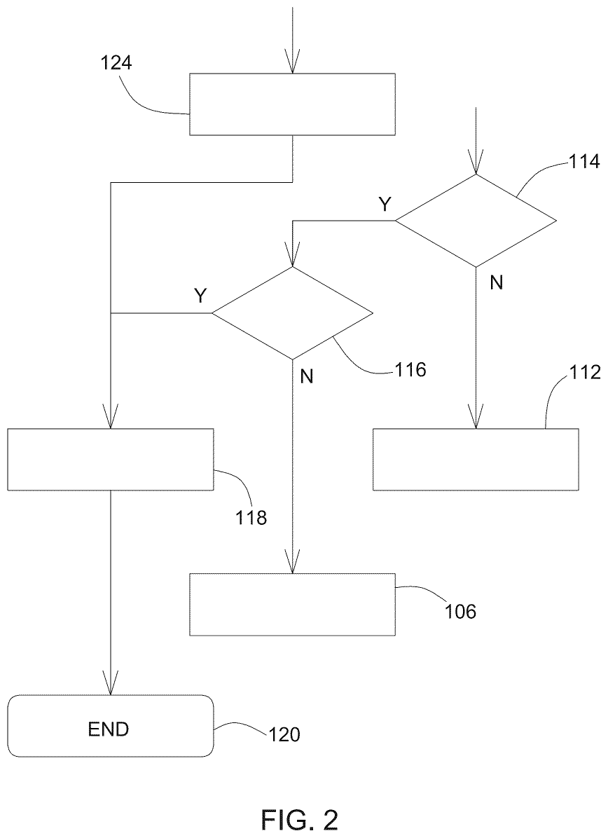

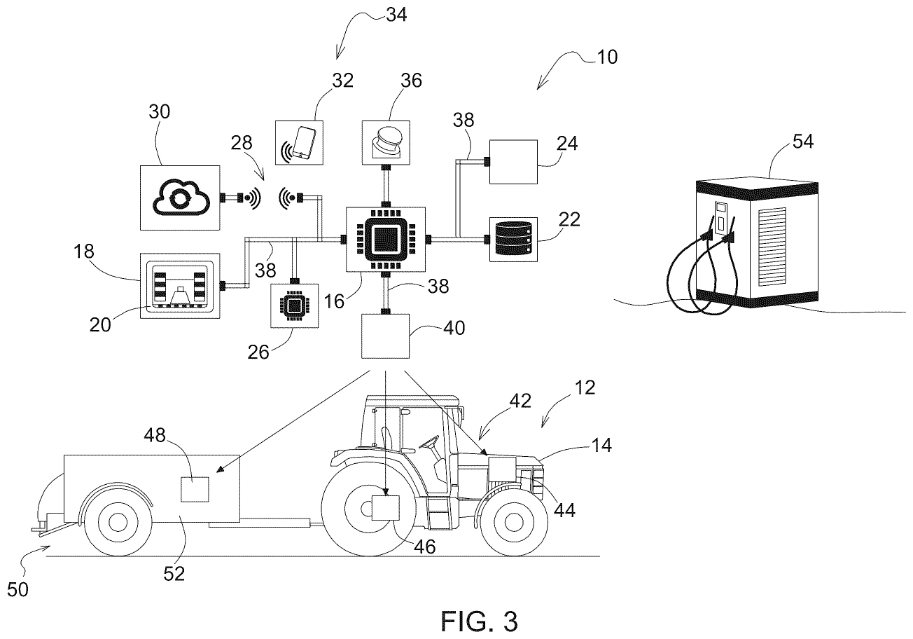

FIGS. 1 and 2 show an example embodiment, which is illustrated as a flow diagram, of the charging management method according to the disclosure for an electrically operated agricultural working vehicle, the function of which is realized in the driver assistance system reproduced in FIG. 3.

In order to provide a better understanding, the structure of the driver assistance system 10 will first be explained. In the present case, the agricultural working vehicle 12 is an agricultural tractor 14, wherein the driver assistance system 10 located therein has, in addition to a microprocessor-controlled control unit 16, a user interface 18 with a display unit 20, a main memory 22, a data memory 24, a data interface 26, a radio interface 28 for establishing a wireless communication connection with an external server 30 or an input apparatus 34 in the form of a mobile device 32, which is used for planning, on the part of the operator, of an agricultural task to be carried out, a GPS navigation system 36, and a CAN data bus 38 connecting the components mentioned above to one another. The input apparatus 34 is a networked farm management system, wherein the actual planning is carried out by way of the mobile device 32 (tablet, smartphone) or a work planning app installed thereon. By way of example, a work planning app of this kind is the John Deere Operations Center.

Furthermore, an electrical energy storage unit 40 arranged in the agricultural tractor 14 is used to supply energy to a drive system 42 with an electric traction drive 44 and various electrical auxiliary and/or working assemblies 46, 48. The latter are part of the agricultural tractor 14 and/or of an add-on or auxiliary device 50 attached thereto. The add-on or auxiliary device 50 is illustrated in FIG. 3 by way of example as a towed fertilizer spreader 52 for spreading dispersible fertilizer granules. The driven auxiliary and/or working assemblies 48 assigned to the fertilizer spreader 52 are used, among other things, to operate one or more throwing discs or an auxiliary wheel drive (not shown).

The electrical energy storage unit 40 is in the form of a rechargeable battery of conventional design and is able to be charged at a charging station 54 shown representatively in FIG. 3. In this case, the charging station 54, comprised by a charging infrastructure that is not shown in any more detail, is only one of a plurality of charging stations. The charging stations are part of a public and/or company-owned charging network and may be permanently installed or else designed to be transportable or mobile. In the case of a transportable or mobile design, these may be integrated in a transport container or the like.

The charging management method stored in the main memory 22 as corresponding program code is started in a starting step 100, whereupon, in a first main step 102, planning data, which are provided by way of the work planning app, of an agricultural task to be carried out (in this case spreading fertilizer granules over one or more agricultural areas) are uploaded to the data memory 24. In a second main step 104, the planning data form the basis of a subsequent estimate or assessment of the total energy requirement to be met in this respect by the electrical energy storage unit 40. More precisely, the total energy requirement to be met by the electrical energy storage unit 40 in the second main step 104 is estimated on the basis of parameters that are specific to an energy consumption that is to be expected for carrying out the agricultural task. The parameters that are specific to the energy consumption that is to be expected are provided to the control unit 16 by way of the input apparatus 34 or the work planning app installed thereon and uploaded to the data memory 24.

If the agricultural working vehicle 12, as in this case, is an agricultural tractor 14, the actual energy consumption is subject to a plurality of influences, which are due to the fact that it is used to universally carry out a wide variety of different tasks, including the operation of associated add-on or auxiliary devices. In such a case, the parameters that are specific to the energy consumption that is to be expected include, for example:
(i) information relating to the efficiency of the electric traction drive 42 comprised by the agricultural tractor 14, including any electrical auxiliary and/or working assemblies 46 present, at different operating points,
(ii) data relating to degradation of the charging capacity of the electrical energy storage unit 40 due to its service life;
(iii) the type and scope of the field cultivation measures to be carried out in the course of the planned agricultural task,
(iv) information relating to the type and state of wear of an add-on or auxiliary device 50 used for this purpose, for example working tools engaging in the soil, to driven auxiliary and/or working assemblies 48 (which are operated by way of an electrically operated power take-off of the agricultural tractor 14 or else by means of dedicated electric drive assemblies), to any support wheels or guide wheels present, to the soil cultivation depth, target working rate and target operating points of the driven auxiliary and/or working assemblies 48, such as predefined target working speeds,
(v) stored data relating to the energy requirement of previous comparable tasks, and/or
(vi) information based on the agricultural area to be cultivated relating to topography, soil type, yield measured values, stock size and density, plant mass, lane profile, weather-dependent soil properties, such as soil moisture and soil condition, as well as the location-dependent compaction due to previous tasks.

These parameters are linked to an electrical energy consumption that is to be expected in this respect by teaching a corresponding AI model (AI—artificial intelligence). The AI model is part of the work planning app.

It should be noted that the above list is of a general nature and does not relate to a specific add-on or auxiliary device 50 (for example, the fertilizer spreader 52). Accordingly, it may also involve a subselection adapted to the respective requirements and/or combination of even further parameters not listed here.

In a third main step 106, the total energy requirement, which is estimated in the second main step 104, is compared with a present state of charge of the electrical energy storage unit 40 by the control unit 16, wherein, if it is found from the comparison that the present state of charge of the electrical energy storage unit 40 is not sufficient to complete the agricultural task without recharging the electrical energy storage unit 40, the control unit 16 initially, in a fourth main step 108, retrieves charging infrastructure information relating to the geographical position of a plurality of charging stations along a route to be covered during the agricultural task from the data memory 24 in order to then, in a fifth main step 110, ascertain whether there is the necessity or intention for a travel interruption of the agricultural tractor 14 to be inserted, depending on the application, along the route to be covered. If that is the case, the method continues with a sixth main step 112.

Such application-dependent travel interruptions occur when filling an add-on or auxiliary device 50 attached to the agricultural tractor 14, which is used to spread a dispersible or liquid consumable located therein, such as fertilizer granules by means of the fertilizer spreader 52 in this case, but also seed, spraying product or slurry.

If, in contrast, it is found from the comparison carried out in the third main step 106 that the present state of charge of the electrical energy storage unit 40 is sufficient to complete the agricultural task without recharging the electrical energy storage unit 40, the method is ended in a final step 120.

In order to be able to make an optimum selection from a plurality of possible charging stations, in the sixth main step 112, the assignment of the geographical position of the travel interruption to be inserted depending on the application is carried out by the control unit 16 depending on selection criteria relating to the accessibility, maximum charging power, the charging current price and/or the present operating state of the plurality of charging stations. By way of example, preference is usually given to a charging station that is able to be reached without a great amount of detours, has a charging power that is as high as possible (measured at the respective charging current price) and is not occupied by another road user. Defective charging stations are also excluded from the outset on the basis of their present operating state. A further selection criterion is whether the charging station in question is part of a public charging network or whether it is preferably a company-owned charging station.

At least some of the factors mentioned above influence the charging time. The selection of the charging station is therefore optimized on the basis of one or more of the selection criteria in such a way that the assignment of the geographical position of the travel interruption to be inserted depending on the application is carried out by the control unit 16 in line with carrying out the charging operation in a time-optimized manner.

In a seventh main step 114 or an eighth main step 116, a check is also carried out to determine whether the state of charge of the electrical energy storage unit 40 resulting from the time period of the application-dependent travel interruption is sufficient to reach the location of a further charging station, in the event of a further application-dependent travel interruption, or to fully complete the agricultural task. If that is not the case, the method returns from the seventh main step 114 to the sixth main step 112 or from the eighth main step 116 to the third main step 106, with the aim of selecting a suitable charging station. Otherwise, the geographical position of the travel interruption to be inserted depending on the application is assigned to the selected charging station 54 and, in a ninth main step 118, is output by way of the data interface 26 in the form of a corresponding charging recommendation. The method is then ended in final step 120.

The charging recommendation is output in the ninth main step 118 by way of the display unit 20 that is connected to the data interface 26 and is in the form of a corresponding driving instruction, for example by displaying a route to be covered to the location of the selected charging station 54. In this case, the route is predefined using the GPS navigation system 36. In addition, a wireless transmission to the external server 30 is provided by means of the radio interface 28, said server using the charging recommendation output by way of the data interface 26 to coordinate a mobile supply vehicle that is sent out to carry out the filling operation at the location of the selected charging station 54.

Relocating the application-dependent travel interruption to the location of the existing charging station 54 makes it possible to reduce (additional) undesired breaks in the workflow to a minimum amount required.

A different method sequence is provided if it is detected by the control unit 16 in the fifth main step 110 that an application-dependent travel interruption is not to be expected in the (further) course of travel or course of work. In this case, the method continues with a tenth main step 122, in which, in a similar manner to the procedure in the second main step 104, the energy requirement that remains for completely carrying out the planned agricultural task after consumption of the existing amount of charge in the electrical energy storage unit 40 is estimated. Depending on the residual energy requirement in an eleventh main step 124, the control unit 16 (starting from the charging options identified in the fourth main step 108), in the ninth main step 118, creates a cartographic overview of possible charging stations and outputs same by way of the display unit 20. The method is then ended in the final step 120 in this case as well.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the any use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the drawings, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation. ” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. A charging management method for an electrically operated agricultural working vehicle including a drive system with a rechargeable electrical energy storage unit, comprising:
estimating via a control unit a total energy requirement to be met by the rechargeable electrical energy storage unit for performing an agricultural task on the basis of parameters that are specific to an energy consumption that is to be expected for performing the agricultural task;
comparing via the control unit the estimated total energy requirement with a present state of charge of the electrical energy storage unit; and
when the comparison that the present state of charge of the electrical energy storage unit is not sufficient to complete the agricultural task without recharging the electrical energy storage unit, the control unit:
(i) retrieves charging infrastructure information relating to a geographical position of a plurality of charging stations along a route to be covered during the agricultural task from a data memory,
(ii) ascertains an intention for a travel interruption of the agricultural working vehicle to be inserted, depending on the application, along the route to be covered, and
(iii) assigns the geographical position of the travel interruption to be inserted depending on the application to at least one of the plurality of charging stations along the route to be covered and outputs a charging recommendation via a data interface.

2. The charging management method of claim 1, wherein the charging recommendation is output via a display unit that is connected to the data interface which includes displaying a route to be covered to the location of the selected charging station.

3. The charging management method of claim 1, wherein the charging recommendation is wirelessly transmitted to an external server via a radio interface, and wherein the external server uses the charging recommendation output via the data interface to coordinate a mobile supply vehicle that is to be sent out to carry out the filling operation at the location of the selected charging station.

4. The charging management method of claim 1, wherein the assignment of the geographical position of the travel interruption to be inserted depending on the application is performed via the control unit depending on selection criteria relating to the accessibility, maximum charging power, the charging current price, and the present operating state of the plurality of charging stations.

5. The charging management method of claim 1, wherein the assignment of the geographical position of the travel interruption to be inserted depending on the application is performed via the control unit in line with performing the charging operation in a time-optimized manner.

6. The charging management method of claim 1, wherein the parameters that are specific to the energy consumption that is to be expected are provided to the control unit by an input apparatus, which is used for planning, on the part of the operator, of the agricultural task to be performed.

7. The charging management method of claim 1, wherein the at least one charging station is selected by the control unit with the aim of the state of charge of the electrical energy storage unit resulting from the time period of the application-dependent travel interruption being sufficient to reach the location of a further charging station.

8. A charging management system for an electrically operated agricultural working vehicle including a drive system with a rechargeable electrical energy storage unit, comprising:
a control unit configured to estimate a total energy requirement to be met by the rechargeable electrical energy storage unit for performing an agricultural task on the basis of parameters that are specific to an energy consumption that is to be expected for performing the agricultural task, and to compare the estimated total energy requirement with a present state of charge of the electrical energy storage unit, and when the comparison that the present state of charge of the electrical energy storage unit is not sufficient to complete the agricultural task without recharging the electrical energy storage unit, the control unit is configured to:
(i) retrieves charging infrastructure information relating to the geographical position of a plurality of charging stations along a route to be covered during the agricultural task from a data memory,
(ii) ascertains an intention for a travel interruption of the agricultural working vehicle to be inserted, depending on the application, along the route to be covered, and
(iii) assigns the geographical position of the travel interruption to be inserted depending on the application to at least one of the plurality of charging stations along the route to be covered and outputs a charging recommendation via a data interface.

9. The charging management system of claim 8, wherein the charging recommendation is output via a display unit that is connected to the data interface which includes displaying a route to be covered to the location of the selected charging station.

10. The charging management system of claim 8, wherein the charging recommendation is wirelessly transmitted to an external server via a radio interface, and wherein the external server uses the charging recommendation output via the data interface to coordinate a mobile supply vehicle that is to be sent out to carry out the filling operation at the location of the selected charging station.

11. The charging management system of claim 8, wherein the assignment of the geographical position of the travel interruption to be inserted depending on the application is performed via the control unit depending on selection criteria relating to the accessibility, maximum charging power, the charging current price, and the present operating state of the plurality of charging stations.

12. The charging management system of claim 8, wherein the assignment of the geographical position of the travel interruption to be inserted depending on the application is performed via the control unit in line with performing the charging operation in a time-optimized manner.

13. The charging management system of claim 8, wherein the parameters that are specific to the energy consumption that is to be expected are provided to the control unit by an input apparatus, which is used for planning, on the part of the operator, of the agricultural task to be performed.

14. The charging management system of claim 8, wherein the at least one charging station is selected by the control unit with the aim of the state of charge of the electrical energy storage unit resulting from the time period of the application-dependent travel interruption being sufficient to reach the location of a further charging station.
